(19) United States
(12) Patent Application Publication
(10) Pub. No.: US 2012/0246551 A1
(43) Pub. Date: Sep. 27, 2012

(54) UPDATING SERIALIZED OBJECTS

(75) Inventors: Gordon D. Patton, Dundee (GB); Andrew Monaghan, Dundee (GB)

(73) Assignee: NCR Corporation, Duluth, GA (US)

(21) Appl. No.: 13/052,421

(22) Filed: Mar. 21, 2011

(51) Int. Cl. G06F 3/048; G06F 17/00

(52) U.S. Cl. 715/227; 715/764

(57) ABSTRACT

A method of updating serialized objects is described. The method comprises: loading a file containing at least one serialized object; identifying classes within the loaded file; ascertaining one or more properties associated with each identified class; and ascertaining for each of the one or more ascertained properties (i) any defined value, and (ii) any alternative values to the defined value. The method further comprises creating a data set to represent (i) the identified classes and (ii) the ascertained properties associated with those classes, where each property includes (a) the defined value and (b) a list of the alternative values that may be selected instead of that defined value. The method further comprises: visually representing the created class data set; and allowing a user to update the class data set by selecting alternative values for one or more properties. A computer for implementing this method is also described.

### FIELD OF INVENTION

The present invention relates to improvements in or relating to updating serialized objects.

### BACKGROUND OF INVENTION

In software, object serialization refers to the process of converting an object into a format that can be stored (for example, in a file or memory buffer) or transmitted (for example, across a network connection link) and subsequently reinstated on the same or a different computer. This enables an object to outlive the program that created it.

In the Microsoft (trademark) .NET framework, objects are commonly serialized to a disk as an XML (eXtensible Markup Language) file. There are standard formats of XML and also proprietary formats of XML. The XML file is used at runtime to reinstantiate objects in a pre-defined state (the state they were serialized in). However, it is sometimes desirable to update a serial object's configuration, but this is not easy to do because it requires the XML file to be edited.

It would be desirable to provide a simple way to update serialized objects without having to recreate and then re-serialize the object.

### SUMMARY OF INVENTION

Accordingly, the invention generally provides methods, systems, and software for a graphical interface for updating serialized objects.

In addition to the Summary of Invention provided above and the subject matter disclosed below in the Detailed Description, the following paragraphs of this section are intended to provide further basis for alternative claim language for possible use during prosecution of this application, if required. If this application is granted, some aspects may relate to claims added during prosecution of this application, other aspects may relate to claims deleted during prosecution, other aspects may relate to subject matter never claimed. Furthermore, the various aspects detailed hereinafter are independent of each other, except where stated otherwise. Any claim corresponding to one aspect should not be construed as incorporating any element or feature of the other aspects unless explicitly stated in that claim.

According to a first aspect there is provided a method of updating serialized objects, the method comprising:

loading a file containing at least one serialized object;

identifying classes within the loaded file;

ascertaining one or more properties associated with each identified class;

ascertaining for each of the one or more properties (i) any defined value, and (ii) any alternative values to the defined value;

creating a class data set to represent the identified classes and the ascertained properties associated with those identified classes, where each ascertained property includes (i) the defined value and (ii) a list of the alternative values that may be selected instead of that defined value;

visually representing the created class data set; and

allowing a user to update the class data set by selecting alternative values for the ascertained properties.

The step of ascertaining one or more properties associated with each identified class may involve using reflection to find all possible properties of each identified class.

The step of creating a class data set to represent the identified classes and the ascertained properties associated with those classes may include creating a hierarchical class data set.

Visually representing the created class data set may include representing the class data set as a table hierarchy (that is, a series of nested tables), where each row in a table represents an instance of an object.

The series of nested tables may include a column in each table for each ascertained property.

The method may include the further step of updating the loaded file in response to the user updating the class data set.

The step of loading a file may be implemented by loading the file from non-volatile memory. The file that is loaded may be in the form of a mark-up language, such as XML.

The method may include the further step of converting the loaded file into a new mark-up language file, where the new mark-up language file includes fields containing values from the updated class data set. The new mark-up language file may also be in XML format.

The method may include the further step of overwriting the file currently stored in non-volatile memory (that is, the file that was loaded) with the new mark-up language file (that is, the file including the updated values). This step may be implemented in response to receipt of save request initiated by the user.

It should be appreciated that this method allows a user to view property values already defined in a serialized object. This method also allows a user to view, and (if desired) select, alternative values to the already defined property values. This allows a user to change the values stored in a serialized object in a manner that is consistent with the class definitions for that object. The user can then save the serialized object so that it includes the changed values instead of the original values.

According to a second aspect there is provided a graphical user interface programmed to:

create a class data set to represent (i) identified classes and (ii) ascertained properties associated with those classes, where each property includes (a) any defined value, and (b) any alternative values to the defined value;

visually represent the created class data set; and

allow a user to update the class data set by selecting alternative values for the ascertained properties.

Selecting alternative values may be implemented by typing in new values or by selecting values from drop down menu lists.

According to a third aspect there is provided a computer program executable by a computer, to perform all of the method steps of the first aspect of the invention.

The computer program may be embodied on a record medium, conveyed on an electrical carrier signal, stored in a computer memory, or the like.

According to a fourth aspect there is provided a computer comprising: a display, a processor, and a storage device operable to store instructions that, when executed by the processor:

load a file from the storage device, where the file contains at least one serialized object;

identify classes within the loaded file;

ascertain one or more properties associated with each identified class;

create a class data set to represent the identified classes and the ascertained properties associated with those classes, where each property includes any alternative values that may be selected;

visually represent the created class data set on the display; and

allow a user to update the class data set by selecting alternative values for one or more properties.

The class data set may be visually represented in the form of a table in which further tables are stored.

According to a fifth aspect there is provided a computer program operable to (i) parse a serialized object into properties, (ii) render a graphical representation of that serialized object including the parsed properties, and (iii) allow editing of values contained in the parsed properties.

The computer program may be further operable to (iv) create code in a serialized object file to represent the edited values.

For clarity and simplicity of description, not all combinations of elements provided in the aspects recited above have been set forth expressly. Notwithstanding this, the skilled person will directly and unambiguously recognize that unless it is not technically possible, or it is explicitly stated to the contrary, the consistory clauses referring to one aspect are intended to apply mutatis mutandis as optional features of every other aspect to which those consistory clauses could possibly relate.

These and other aspects will be apparent from the following specific description, given by way of example, with reference to the accompanying drawings.

### BRIEF DESCRIPTION OF THE DRAWINGS

FIG. 1 is a simplified block diagram illustrating a computer executing software components, including a serialized object updating program, according to one embodiment of the present invention;

FIG. 2 is a pictorial diagram illustrating a class hierarchy of an object;

FIG. 3 is a listing of an XML file that is a serialized object based on the class hierarchy of FIG. 2;

FIG. 4 is a flowchart illustrating steps performed by the serialized object updating program of FIG. 1 to create a graphical user interface (GUI) that represents the serialized object of FIG. 3;

FIG. 5 is a pictorial diagram illustrating the GUI representation of the serialized object of FIG. 3 as rendered on the display 30 by the serialized object updating program of FIG. 1; and

FIG. 6 is a pictorial diagram illustrating how the serialized object program of FIG. 1 may render a serialized object relating to a card reader program.

### DETAILED DESCRIPTION

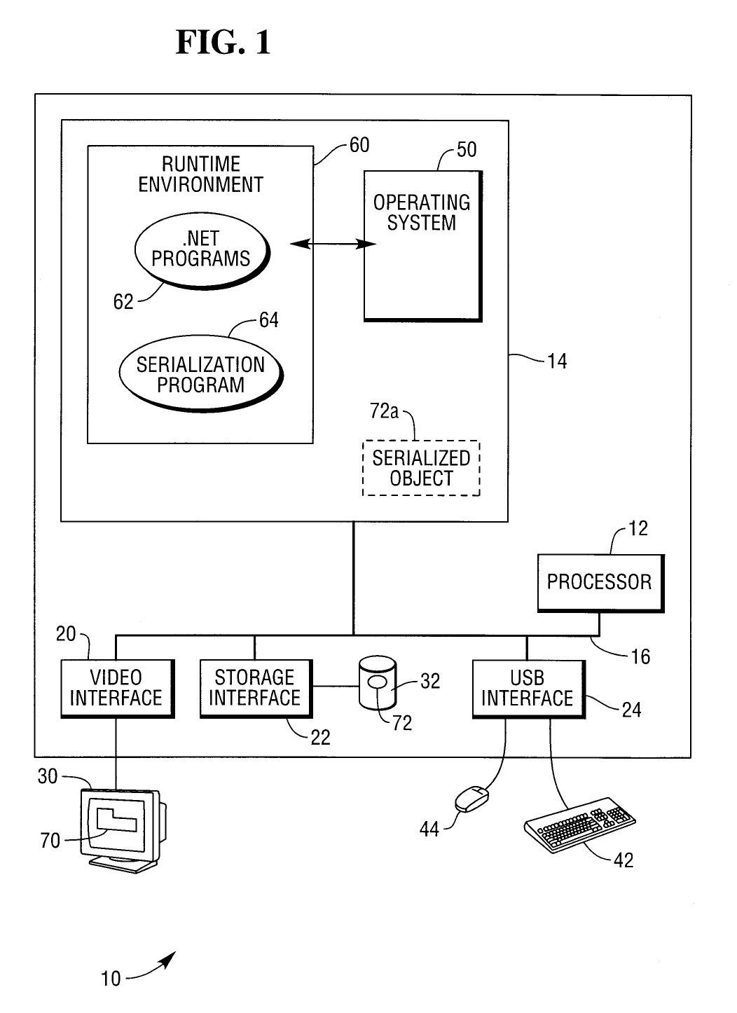

Reference is first made to FIG. 1, which is a simplified block diagram illustrating a computer 10 executing software components according to one embodiment of the present invention.

The hardware in the computer 10 is conventional, so will only be described briefly herein.

The computer 10 comprises a processor 12 coupled to volatile memory

(RAM) 14 by a system bus 16. The processor 12 is also coupled, inter alia, to a video interface 20, a non-volatile storage interface 22, and a USB interface 24.

The video interface 20 is coupled to a display 30 for outputting information to a user. The non-volatile storage interface 22 is coupled to a disk drive 32 for permanent (non-volatile) storage of data and instructions, and also to removable media players (not illustrated, but including a compact disc player and/or a digital versatile disc (DVD) player). The USB interface 24 is coupled to a keyboard 40, a mouse 42, and any other desired hardware input devices (such as a writing tablet).

The software components executing in the memory 14 will now be described.

The memory 14 includes a conventional operating system kernel 50. In this embodiment, the operating system 50 comprises the Windows XP (trade mark) operating system, available from Microsoft Corporation (trade mark).

The memory 14 also includes a runtime environment 60. In this embodiment the runtime environment 60 implements the .NET framework and includes programs 62 for supporting this framework. These programs are well known (such as a just-in-time compiler) and commercially available, so they will not be described in detail herein.

The runtime environment 60 also includes an object serialization editor 64. The object serialization editor 64 (also referred to as a serialized object updating program) provides a graphical user interface (GUI) that allows a user to view properties associated with serialized objects and to change those properties using the GUI. The changes can then be saved to the serialized objects so that the serialized objects are available for use with the new (updated) properties.

The object serialization editor 64 creates a graphical user interface 70 that is rendered on the display 30.

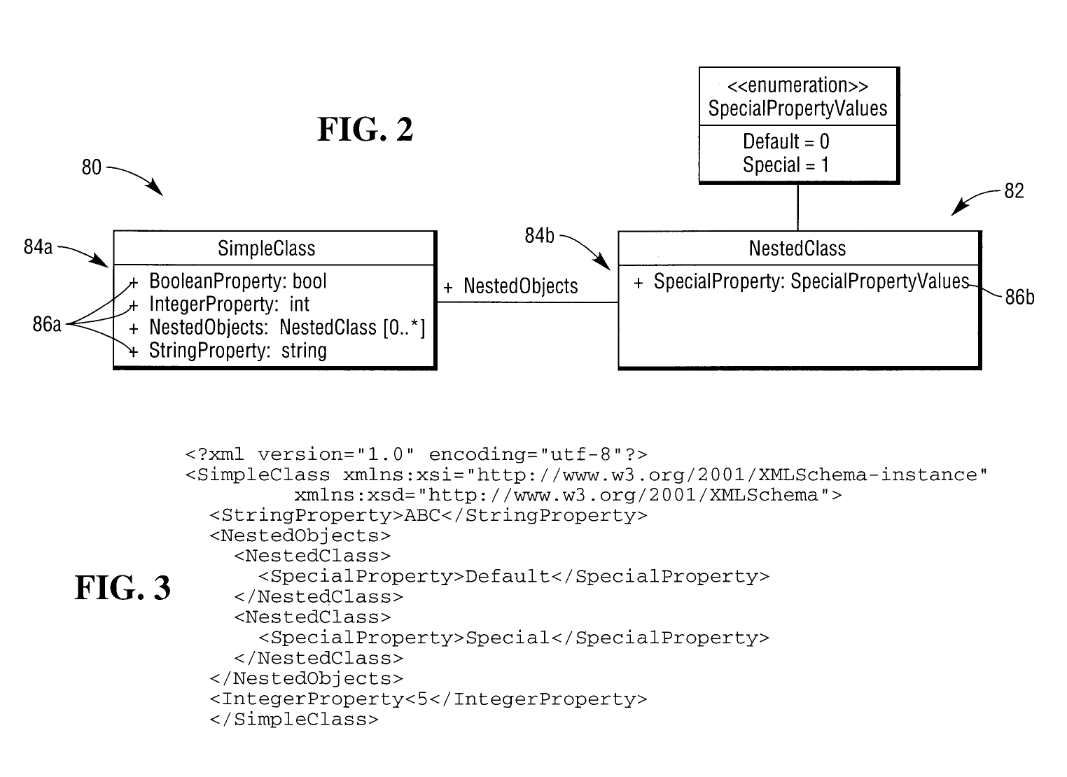

The operation of the object serialization editor 64 will now be described with reference to FIGS. 2 to 5.

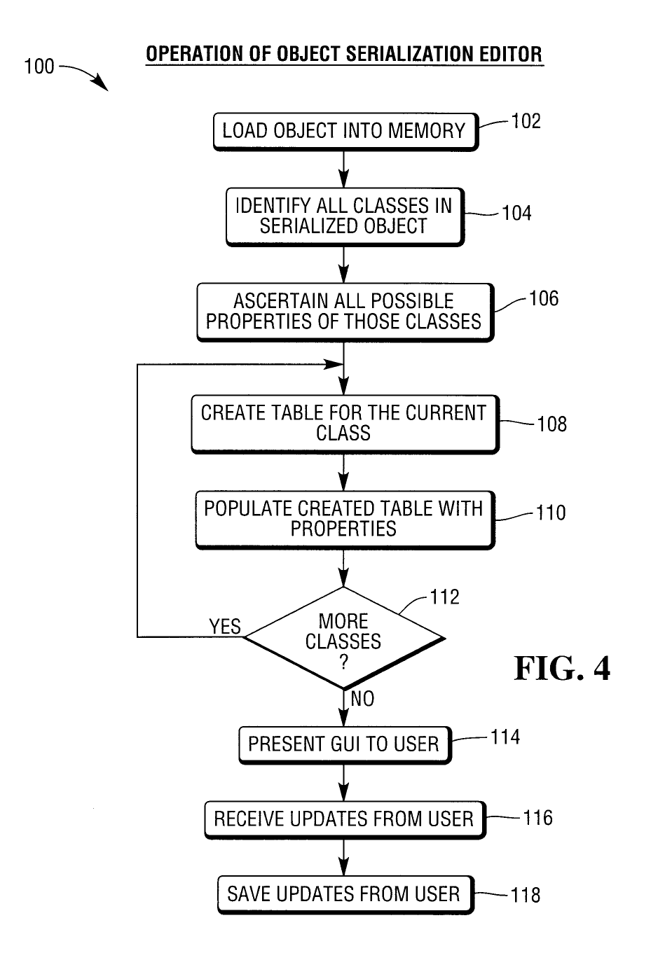

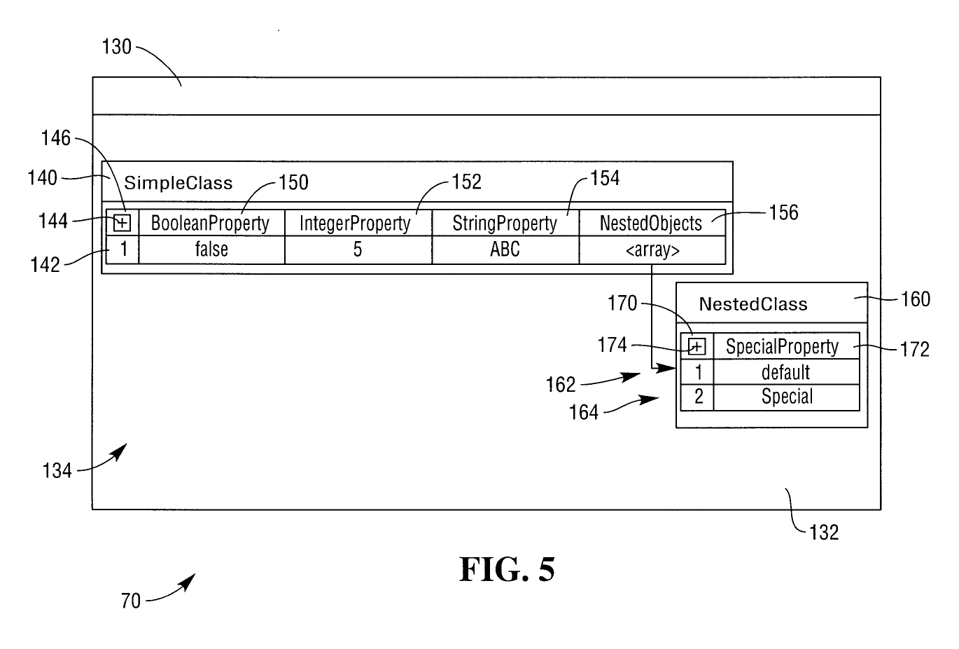

FIG. 2 is a pictorial diagram illustrating a class hierarchy of an object, of which serialized object 72 stored in the disk drive 32 is an instance. FIG. 3 is a listing of an XML file that represents the serialized object 72. FIG. 4 is a flowchart illustrating steps performed by the object serialization editor 64 to create a visual representation of the classes 80,82 from the class hierarchy of FIG. 2. FIG. 5 is a pictorial diagram illustrating the GUI representation of the serialized object 72 as rendered on the display 30.

Referring first to FIG. 2, two classes are illustrated: a main class 80 (labeled SimpleClass) and a nested class 82 (labeled NestedClass). Each class 80,82 has one or more fields 84 (each of which may relate to a nested class or a property). The nested class 82 is shown as a field in the main class 80. The main class 80 defines three properties (String, Integer, and Boolean) 86a in the fields 84a; whereas, the nested class 82 defines only one property (Special) 86b in its field 84b.

Reference is now also made to FIG. 3, which is a listing of an XML file corresponding to the serialized object 72 that was derived from the object class hierarchy of FIG. 2. In FIG. 3, there is one instance of the main class 80 and two instances of the nested class 82. However, the BooleanProperty is not defined in the serialized object 72, even though it exists as a possible property in the object's class hierarchy.

Reference is now also made to FIG. 4, which is a flowchart 100 illustrating steps performed by the object serialization editor 64 of FIG. 1 to create a graphical representation of the classes 80,82 in the class hierarchy of FIG. 2.

Initially, the object serialization editor 64 loads the serialized object 72 from the disk drive 32 into memory 14 (step 102). When loaded into memory 14, the serialized object 72 is referred to herein as serialized object 72a. This is because an instance of the serialized object 72 exists on the disk drive 32 (as a file) and another instance of the serialized object 72a exists in the memory 14. For simplicity of explanation, it is assumed in this embodiment that only a single object is stored in the file on the disk drive 32. In practical embodiments, the file stored on disk drive 32 may contain multiple objects, each of which is handled as described herein.

The object serialization editor 64 then identifies all of the classes in the serialized object 72a (step 104). This is implemented by the object serialization editor 64 identifying all of the class tags in the XML file. For example, in FIG. 3 there are three classes: one “SimpleClass” class and two “NestedClass” classes.

The object serialization editor 64 then uses reflection (which is a service supported by the .NET framework programs 62 and well known to those of skill in the art) on each identified class to ascertain all possible properties of that class (step 106), even if those properties have not been defined in the serialized object 72a. For example, the BooleanProperty is defined in the main class 80, but it not present in the serialized object 72a, as shown in FIG. 3.

The object serialization editor 64 then defines a class data set that will include all classes and all of their properties. This is implemented by the object serialization editor 64 defining a table for the current class (which is the top level class (the main class 80) the first time that this occurs) in the serialized object 72a (step 108).

The object serialization editor 64 then populates this created table with properties of that current class (step 110).

The object serialization editor 64 ascertains if there are any other classes (such as nested class 82) in the serialized object 72a (step 112).

If there are other classes then the object serialization editor 64 repeats steps 108 and 110 to create and populate an embedded table for each of these classes. In this example there are two nested classes 82 so one column of the main class is populated with a reference to another table (a nested or embedded table). This nested table includes two rows, one row for each instance of the nested class 82.

Steps 108 through to 112 are performed iteratively. Each type of class is allocated a table (for example, SimpleClass is allocated one table, and NestedClass is allocated another table, which is embedded in the SimpleClass table). If there are multiple instances of one type of class (for example, there are two instances of NestedClass in FIG. 3) then each instance of that class is allocated a unique row within that class table.

If an instance of a class has a simple property, then the value of that property is added to a cell in a column dedicated to that property on a row associated with that instance.

If an instance of a class has complex property (for example, a reference to another class), then a link to a new table (for that other class) is added to a cell in a column dedicated to that property on a row associated with that instance.

The object serialization editor 64 also adds a control to each table to allow a user to add another row within that table. Such a new row would represent another instance of the class associated with that table. This will be described in more detail below.

Once all of the nested classes have been converted into embedded tables, and the tables have been populated with the property values from the serialized object 72a, then the object serialization editor 64 renders the GUI 70 to present a visual representation of the serialized object 72a to a user of the computer 10 (step 114), as illustrated in FIG. 5.

The GUI 70 allows a user to update the serialized object 72a (step 116), as will now be described with reference to FIG. 5. As shown in FIG. 5, the GUI 70 includes a menu bar 130 and a display area 132 beneath the menu bar 130. Although not illustrated in detail, the menu bar 130 includes options to allow a user to open a serialized object, to save a serialized object, to close a serialized object, and the like.

A visual representation 134 of the serialized object 72 is presented in the display area 132. The visual representation 134 is in the form of an array (specifically, nested tables). A highest level table 140 (labeled “SimpleClass”) includes only one row 142 (the “main class row”) because only one instance of this type of class is present in the serialized object 72a. The main class row 142 indicates that an instance of the SimpleClass is present, and provides the values of the properties in that SimpleClass that are present in the serialized object 72a.

There is the possibility of adding another instance of the main class 80 (and also of deleting any added instances of the main class). This can be implemented by the user selecting an insertion button 144 on the first column (the control column) 146 of the highest level table 140. The GUI 70 then adds a row similar to row 142 (referred to as a second main class row); namely, a row with the same columns but with empty or default values in the cells for that row that are under those columns.

The main class row 142 includes four additional columns (not including the control column 146). Three of these columns 150,152,154 relate to properties of the main class 80 and the fourth additional column 156 includes a reference to the nested class instances. It is important to recognize that the columns 150 to 154 list the properties defined by the class, even if the particular instance of the class represented by a row does not include some of those properties. This enables defined properties in a class to be added to an instance even after the instance has been serialized without those defined properties.

The first additional column 150 relates to the Boolean property. This property is not defined in the serialized object 72a, so the entry (that is, the value of the cell under that column 150) is “False”. A user can define this property by clicking on that cell and typing True (or selecting True from a drop down list).

The second additional column 152 relates to the Integer property. This property is defined in the serialized object 72a. The object serialization editor 64 extracts this value (“5”) therefrom and populates the main class row 142 with this value under the Integer property column 152. Again, this Integer property can be updated by the user clicking on the cell and entering a value (since the property value is not constrained). If a property value is constrained to one of a small number of options, then a drop down menu list may be provided that the user can select from.

The third additional column 154 relates to the String property. This property is defined in the serialized object 72a and its value (“ABC”) is extracted by the object serialization editor 64 and is shown in the cell in the main class row 142 under that column 154. Again, this String property can be updated by clicking on the cell and entering a value (since the property value is not constrained).

The fourth additional column 156 relates to the two nested classes 82 and includes an embedded table 160. The embedded table 160 is similar to the highest level table 140 but includes two rows 162,164 (since there are two instances of the nested class 82) but only two columns 170,172 (because only one property is defined by the class hierarchy for this class). The first column 170 is a control column (for adding rows to that embedded table 160) and the second column 172 is Special property column 174. There is only one property column (the Special property column 174) because there is only one property defined in the nested class 82.

The user can add more instances of the nested class 82 by clicking on an insertion button 174 in the control column 170, in a similar way to the highest level table 140. The user can also delete an instance of the nested class 82 by clicking on a deletion button (not shown) in the control column 170.

Once a user has reviewed and changed the property values as desired, the user can select a save option (not shown) from the menu bar 130 to save the changes to the serialized object 72 on the storage device 32 (step 118). This causes the object serialization editor 64 to create an XML file having the format shown in FIG. 3, but with the updated values (including any new class instances) entered into the GUI 70 included in that XML file.

The object serialization editor 64 then instructs the operating system 50 to overwrite the serialized object 72 with the new XML file created from the updated serialized object 72a.

It should now be appreciated that this embodiment allows a user to examine and modify a serialized object using a graphical user interface, and then to save the modified serialized object in a form that is ready for use by another program.

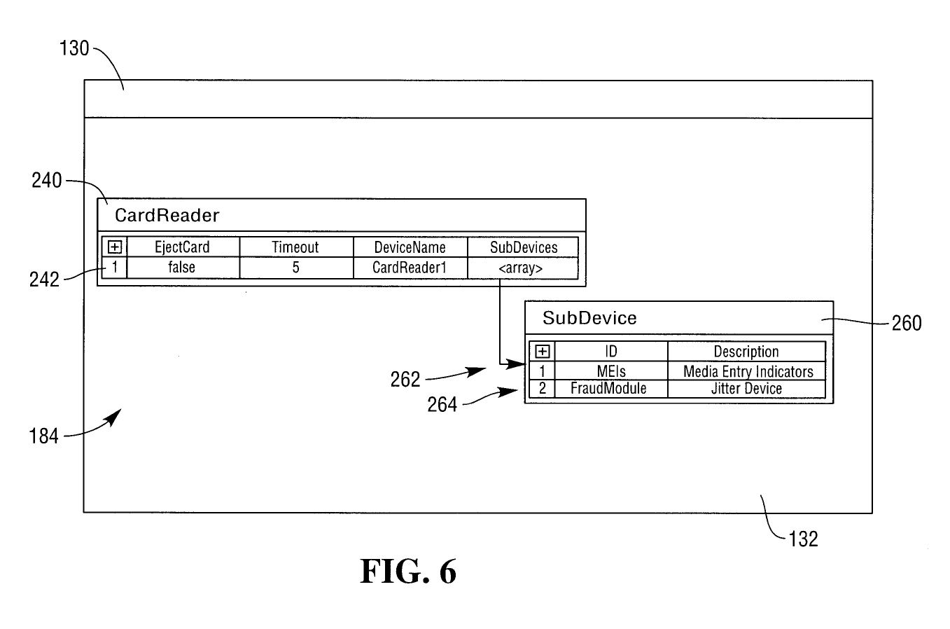

Reference is now also made to FIG. 6, which is a pictorial view of a visual representation 184 of classes and nested classes in a card reader application. This representation is created by the object serialization editor 64 using the method illustrated in the flowchart 100.

The visual representation 184 is in a similar form to visual representation 134. The highest level table in FIG. 6 is the CardReader class 240, and it includes only one row 242 (the “main class row”). The main class row 242 indicates that an instance of the CardReader class 240 is present, and provides the values of the properties in that CardReader class that are present in the corresponding serialized object.

The properties shown in the CardReader class 240 include: an EjectCard property (which is a Boolean property indicating if an inserted card should be automatically ejected after it is inserted); a Timeout property (indicating the maximum length of time in seconds to wait for a card insertion); and a DeviceName property (indicating a name of the physical device that is being controlled).

The CardReader class main class row 242 also includes a nested class 260. The nested class 260 includes two instances (hence there are two rows). The nested class 260 is labeled SubDevices. This class relates to additional sub-devices used by the card reader.

The nested class 260 includes two properties: an identification of the sub-device, and a description of the sub-device. There are two instances of sub-devices listed: a media entry indicator sub-device 262, and fraud module sub-device 264.

Various modifications may be made to the above described embodiment within the scope of the invention, for example, in other embodiments, the number of main classes may be greater than one, and the number of nested classes may be greater or smaller than two. In other embodiments, multiple levels of class nesting may be used.

In other embodiments, the object serialization editor 64 may identify all of the classes in the serialized object 72a (step 104) in a different way to that described, for example, by searching for a defined text string.

In other embodiments, the class data set may be stored and/or presented in a format other than a tabular format.

The steps of the methods described herein may be carried out in any suitable order, or simultaneously where appropriate. The methods described herein may be performed by software in machine readable form on a tangible storage medium or as a propagating signal.

The terms “comprising”, “including”, “incorporating”, and “having” are used herein to recite an open-ended list of one or more elements or steps, not a closed list. When such terms are used, those elements or steps recited in the list are not exclusive of other elements or steps that may be added to the list.

Unless otherwise indicated by the context, the terms “a” and “an” are used herein to denote at least one of the elements, integers, steps, features, operations, or components mentioned thereafter, but do not exclude additional elements, integers, steps, features, operations, or components.

The presence of broadening words and phrases such as “one or more,” “at least,” “but not limited to” or other similar phrases in some instances does not mean, and should not be construed as meaning, that the narrower case is intended or required in instances where such broadening phrases are not used.

What is claimed is:

1. A method of updating serialized objects, the method comprising:
loading a file containing at least one serialized object;
identifying classes within the loaded file;
ascertaining one or more properties associated with each identified class;
ascertaining for each of the one or more ascertained properties (i) any defined value, and (ii) any alternative values to the defined value;
creating a class data set to represent (i) the identified classes and (ii) the ascertained properties associated with those identified classes, where each ascertained property includes (a) the defined value and (b) a list of the alternative values that may be selected instead of that defined value;
visually representing the created class data set; and
allowing a user to update the class data set by selecting alternative values for the ascertained properties.

2. A method according to claim 1, wherein the step of ascertaining one or more properties associated with each identified class uses reflection to find all possible properties of each identified class.

3. A method according to claim 2, wherein the step of creating a class data set to represent the identified classes and the ascertained properties associated with those classes includes creating a hierarchical class data set comprising a series of nested tables, where each row in a table represents an instance of an object.

4. A method according to claim 3, wherein the series of nested tables includes a column in each table for each ascertained property.

5. A method according to claim 1, wherein the method includes the further step of updating the loaded file in response to the user updating the class data set.

6. A method according to claim 5, wherein the step of updating the loaded file includes converting the loaded file into a mark-up language file.

7. A method according to claim 6, wherein the method includes the further step of overwriting the file that was loaded with the mark-up language file.

8. A computer program executable by a computer, to perform the method steps of claim 1.

9. A computer program according to claim 8, wherein the computer program is embodied on a record medium.

10. A computer comprising: a display, a processor, and a storage device operable to store instructions that, when executed by the processor:
load a file from the storage device, where the file contains at least one serialized object;
identify classes within the loaded file;
ascertain one or more properties associated with each identified class;
create a class data set to represent the identified classes and the ascertained properties associated with those classes, where each property includes any alternative values that may be selected;
visually represent the created class data set on the display; and
allow a user to update the class data set by selecting alternative values for one or more properties.

11. A computer according to claim 10, wherein the class data set comprises a table in which further tables are stored.

12. A computer program operable to:
(i) parse a serialized object into properties,
(ii) render a graphical representation of that serialized object including the parsed properties, and
(iii) allow editing of values contained in the parsed properties.
